(19) United States
(12) Patent Application Publication
(10) Pub. No.: US 2010/0153270 A1
(43) Pub. Date: Jun. 17, 2010

(54) AUTHENTICATION OF MESSAGE RECIPIENTS

(75) Inventor: Michael Ian Hawkes, Manchester (GB)

Correspondence Address: BARLOW, JOSEPHS & HOLMES, LTD., 101 DYER STREET, 5TH FLOOR, PROVIDENCE, RI, 02903, US

(73) Assignee: BROCA COMMUNICATIONS LIMITED, Manchester (GB)

(21) Appl. No.: 12/516,490

(22) PCT Filed: Nov. 26, 2007
(86) PCT No.: PCT/GB2007/004516

§ 371 Date: Dec. 1, 2009

(30) Foreign Application Priority Data
Nov. 27, 2006 (GB) 0623601.2

(51) Int. Cl. G06Q 40/00; H04L 9/32; H04L 9/08; H04L 9/30; H04L 9/06

(52) U.S. Cl. 705/44; 726/6; 713/170; 380/30; 380/259; 380/44; 380/283

(57) ABSTRACT

A user receives a message via a network service platform at their mobile handset. The user is required to input a PIN, password or other authentication data, before the received message is displayed. The service platform generates a partial encryption key and embeds this within a message which is subsequently encrypted and transmitted to the receiving device. The receiving device or handset receives the message and decrypts it using a previously stored pseudo-random seed, combined with a user entered PIN. The receiving device or handset extracts the partial key delivered with the message and uses this key data to generate a new pseudo-random seed which, in turn, is used to generate a sequence of characters in apparently random order. This sequence of characters or numbers is presented in a text-only form with a cursor or other highlighting method selecting the first character in the pseudo-random sequence. The user is then able enter their PIN by using cursor control keys, such as the right/left keys. The device or handset validates the data entry, assuming that the secure data is valid, displays the message content.

The present invention relates to authentication of message recipients and in particular to a method of authenticating message recipients by generating a pseudo-random sequence of selectable characters for entry of authentication data such as a PIN.

When a person enters data via a keyboard or similar entry mechanism, malicious software is capable of detecting the keys pressed and providing this data to third parties. In order to prevent third parties from accessing sensitive data such as passwords or personal identification numbers (PINs), a mechanism is required to prevent malicious third parties from recording key-presses and replaying them to gain access to otherwise secured activities.

Generating a random sequence of characters and asking users to select from them using cursor keys (or via a pointer) will remove the ability to perform keyboard replays but introduces significant issues when testing entry systems or providing forensic data with respect to the actual activities undertaken to enter a PIN or password.

For many mobile devices, display capabilities are significantly reduced when compared to the complex graphical user interfaces of most modern computer systems. A simple ‘text-only’ pseudo-random entry system is required for these types of devices.

It is therefore an object of the present invention to provide a method of providing secure entry of data, particularly (although not exclusively) for devices with limited display capabilities, in a repeatable way, under the control of a remote platform.

According to a first aspect of the present invention there is provided a method for authenticating a user as recipient of a message, the method comprising the steps of: generating a pseudo-random character sequence; displaying said pseudo-random character sequence to the user; enabling the user to input authentication data by selecting one or more characters from the displayed pseudo-random character sequence; determining whether the authentication data is valid; and, if the authentication data is valid, displaying the message characterised in that a seed for generating the pseudo-random character sequence is extracted from the message.

By use of the above method, authentication data can be entered without exposing the user to potential security issues from key logging applications. Furthermore, if the seed is known, the actual generation of the character sequence is effectively controlled (and may be audited) by a remote platform.

The authentication data may be a PIN, password, answer to a security question, account number, date of birth or similar. In some embodiments, a plurality of different authentication data must be entered. In other embodiments, only specific parts of the authentication data need be entered, for example the second, fourth and seventh characters in an eight character password.

The message is preferably an encrypted message. Preferably, the method includes the further step of decrypting the message. The message may be decrypted by use of a key held by the user. The seed may also act as a key for decryption of one or more future messages. In such embodiments, the method preferably involves the additional step of storing the seed for use as a decryption key. Additionally or alternatively, the seed may also be used for other purposes.

In some embodiments, the seed may be a partial key from which a complete key can be generated. The complete key may be generated by combining the partial key with some other information held by the user or on a user's message receiving device. Typically, this may be the user authentication data.

The seed may be a key or may generate a complete key having limited validity. The seed may be encrypted along with the message or may be transmitted in unencrypted form alongside an encrypted message. The seed may be or may generate a symmetric key or an asymmetric public or private key.

The seed may be a partial seed, from which a full seed may be generated. The full seed may be generated by combining the partial seed with some other information held by the user or on a user's message receiving device.

The pseudo-random character sequence may be generated by inputting the seed into a suitable algorithm. Examples of suitable types of algorithms include linear congruential generators, lagged Fibonacci generators, linear feedback shift registers, and generalised feedback shift registers. Particular algorithms that may be used in some embodiments include Blum Blum Shub, Fortuna and the Mersenne twister.

The selection of characters may be carried out using cursor keys, a pointer device such as a mouse, touchpad, track ball or similar. In some embodiments, the selection may take place directly by use of a touch sensitive display.

The pseudo-random character sequence may be displayed in any suitable layout. Preferably, the character sequence is displayed as a simple line of text. One character in the sequence may be highlighted to indicate that it is currently available for selection. Once a character has been selected, a masked character representing this selection may be displayed in an authentication data area of the display. This enables the user to tell how many characters have already been selected.

The characters displayed may be numerals, letters or other symbols or any desired combination thereof.

The seed may also be used as a key or for generating a key (perhaps in combination with some other data) for the encryption of one or more messages sent by the user. The messages may be generated and/or sent automatically in response to a valid entry of authentication data. Additionally or alternatively, the method may include the additional steps of: generating a pseudo-random character sequence; displaying said pseudo-random character sequence to the user; enabling the user to input authentication data by selecting one or more characters from the displayed pseudo-random character sequence; determining whether the authentication data is valid; and, if the authentication data is valid, sending the message characterised in that a seed for generating the pseudo-random character sequence is extracted from a previously received message.

The messages may be received from or via an authentication system. The authentication system may be a subsystem of a network service platform. The seed is preferably inserted into the message by the authentication system. Preferably the message is encrypted by the authentication system.

According to a second aspect of the present invention there is provided a method for authenticating a user as a sender of a message, the method comprising the steps of: generating a pseudo-random character sequence; displaying said pseudo-random character sequence to the user; enabling the user to input authentication data by selecting one or more characters from the displayed pseudo-random character sequence; determining whether the authentication data is valid; and, if the authentication data is valid, sending the message characterised in that a seed for generating the pseudo-random character sequence is extracted from a previously received message.

The method for authenticating a user as a sender of a message may incorporate any or all of the features described in relation to the first aspect of the invention as desired or as appropriate.

According to a third aspect of the present invention there is provided a secure messaging method incorporating the method for authenticating a user as recipient of a message in accordance with the first or second aspects of the present invention.

The secure messaging method may incorporate any or all of the features described in relation to the first and/or second aspects of the present invention as desired or as appropriate.

The secure messaging method may be a secure messaging method of the type disclosed in our prior International Patent Application No WO 03/063528, the content of which is incorporated herein by reference, wherein an authentication system stores identification information of a plurality of providing users and a plurality of receiving users and is adapted to: receive information from and authenticate at least one of said providing users; and transmit a message including said information via a mobile communications network to a receiving user's mobile terminal; further being adapted to:

extract a public key specific to said receiving user from said stored identification information and to use said user specific public key for encryption of at least part of said message; provide a communication specific public/private key pair valid only for a single communication between the authentication system and said receiving user, wherein said communication comprises a message and a response thereto; encrypt at least part of said message using said communication specific private key; and send said communication specific public key to said receiving user as part of said message or send said communication specific public key to said receiving user terminal prior to said communication and store said communication specific public key in said mobile terminal.

According to a fourth aspect of the present invention there is provided a method of authenticating electronic payments comprising the steps of: sensing a message to a user; authenticating the user in accordance with the method of the first or second aspects of the present invention; and thereby authenticating the payment.

The method of the fourth aspect of the present invention may incorporate any or all of the features described in relation to the first, second and/or third aspects of the present invention as desired or as appropriate.

The message sent to the user may contain details of a payment to be made. The details may include any of: a total or itemised amount; and details of the relevant goods and/or or services. The method may include the further step of sending a response method confirming the transaction and thus releasing payment.

According to a fifth aspect of the present invention there is provided a data transfer network wherein data is transferred by secure messages in accordance with the third aspect of the present invention.

The data transfer network of the fifth aspect of the present invention may incorporate any or all of the features described in relation to the first, second, third and/or fourth aspects of the present invention as desired or as appropriate.

The data transfer network may be a fixed wire or wireless network. In particular, the data transfer network may be a telephone network.

The data transfer network may be a data transfer network of the type operable to implement a secure messaging method of the type disclosed in our prior International Patent Application No WO 03/063528.

According to a sixth aspect of the present invention there is provided a device operable to authenticate a user in accordance with the first or second aspect of the present invention, to receive and/or send messages in accordance with the first, second or third aspects of the present invention and/or to authenticate an electronic payment accordance with the fourth aspect of the present invention and/or to connect to a data transfer network in accordance with the fourth aspect of the present invention.

The device operable to receive messages may incorporate any or all of the features described in relation to the first, second, third, fourth and/or fifth aspects of the present invention as desired or as appropriate.

Suitable types of device would include, but are not limited to mobile or fixed line telephones, personal digital assistants (PDAs), portable or desktop computers and/or other audio visual equipment.

In order that the invention can be more clearly understood it is now described further below with reference to the accompanying drawings:

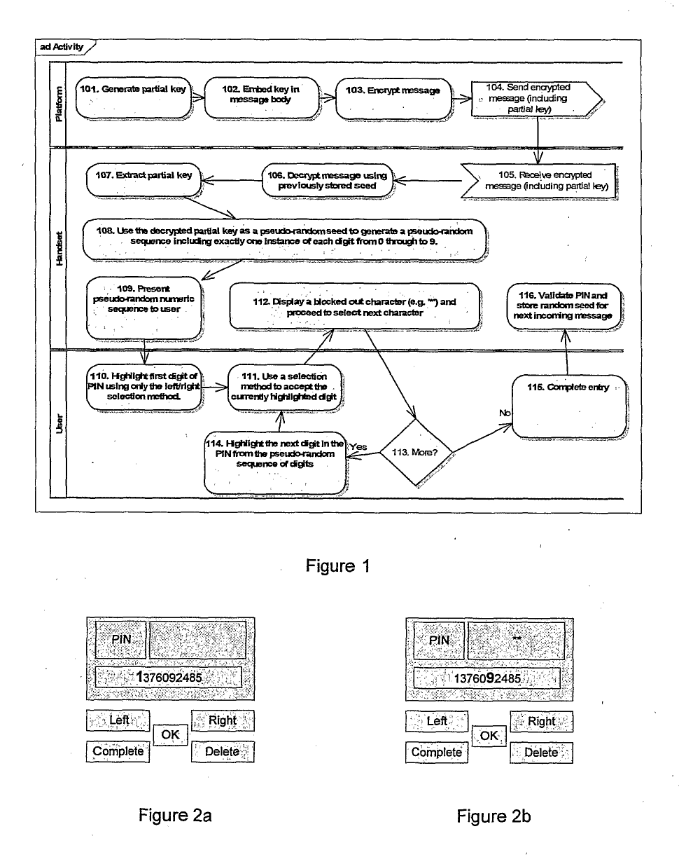

FIG. 1 is a schematic flow diagram illustrating the method of the present invention;

FIG. 2a is a schematic illustration of an initial stage in the input of authorisation data by a user in the present invention; and

FIG. 2b is a schematic illustration of a later stage in the input of authorisation data by a user in the present invention.

Referring now to FIG. 1, there is shown a flow diagram illustrating one possible implementation of the present invention. In this example, a user receives a message via a network service platform at their mobile handset. The user is required to input a PIN, password or other authentication data, before the received message is displayed.

In the diagram above, the service platform generates a partial encryption key (101) and embeds this within a message (102) which is subsequently encrypted (103) and transmitted to the receiving device (104):

The receiving device or handset receives the message (105) and decrypts it (106) using a previously stored pseudo-random seed, combined with a user entered PIN (steps 109 to 116). The handset uses a default pseudo-random seed, provided with the application, on the initial occasion the process is used: on all subsequent occasions a platform-generated seed is used.

The receiving device or handset extracts the partial key delivered with the message (107) and uses this key data to generate a new pseudo-random seed which, in turn, is used to generate a sequence of characters in an apparently random order (108). This sequence of characters or numbers is presented in a text-only form with a cursor or other highlighting method selecting the first character in the pseudo-random sequence (109).

The user is then able to select or highlight the first character of their PIN (110) by using cursor control keys (such as the right/left keys). When the currently highlighted character matches the user's first PIN character, the user presses another key (such as an ‘enter’ or ‘select’ key) to accept the currently highlighted character (111).

At this point, the device or handset displays a masked character such as an “*” or ‘#’ (112) to indicate that a character was selected. If more characters are required (113) then the user can enter more characters (114) as required. Backspace functionality may also be provided by this method, but is excluded from the diagram to aid clarity. When the PIN entry is complete, the user may indicate this by selecting another key (115) such as an ‘enter’ or ‘next’ key on the device or handset.

Referring now to FIG. 2a, the number ‘1’ is highlighted. The character sequence is presented in a simple text layout (not in a grid or graphical layout). This makes selection simpler for devices with limited number of keys or limited display capabilities. The user may use the left/right keys to change the highlighted character to select the first character of their PIN. FIG. 2b, now shows the same user interface after entry of two digits. In this case, the number ‘9’ is highlighted and the previously entered data is shown in the PIN field as ‘**’, indicating that two previous characters were highlighted and selected by the user.

The device or handset validates the data entry and, assuming that the secure data is valid, displays the message content and stores the partial key as a pseudo-random seed for future use. The partial key is used to decrypt the next incoming message, but requires successful entry of the PIN to complete the key and decrypt the next message payload.

By providing this method, an automated test tool or forensic examination tool can use exactly the same pseudo-random number generators to provide simulated key-presses that would mimic a real user. This is because an automated test harness would already know the characters required to complete the PIN, and because the test tool would know the pseudo-random sequence, it could then emulate real-user interaction accurately. The actual PIN is never revealed, therefore, this method provides a secure, yet repeatable, PIN entry system that is immune from keyboard capture software.

The use of a partial encryption key for generating the pseudo-random sequence cuts down the amount of data that needs to be transferred to enable secure authentication. As the encryption key doubles as a pseudo-random seed, any suitable key exchange method may be used to ensure that new keys or one time only keys are transmitted securely to the user. In particular, the key exchange method may be a method of the type disclosed in our prior international application WO 03/063528.

This method may be applied to any messages transmitted via the network platform. This may include peer to peer messages or business to peer messages. In particular, the method may be applied to authenticating electronic payments. In such a system a merchant may transmit a message to a user via the platform containing details of a payment to be made in respect of goods and or services. The user may then authenticate themselves as message recipients by entry of a PIN and choose to send a response method confirming the transaction and thus releasing payment to the merchant.

It is of course to be understood that the invention is not to be restricted to the details of the above embodiments which have been described by way of example only.

1. A method for authenticating a user as recipient of a message, the method comprising the steps of: generating a pseudo-random character sequence; displaying said pseudo-random character sequence to the user; enabling the user to input authentication data by selecting one or more characters from the displayed pseudo-random character sequence; determining whether the authentication data is valid; and, if the authentication data is valid, displaying the message, the method being characterised in that a seed for generating the pseudo-random character sequence is extracted from the message, wherein the messages are received from or via an authentication system and the seed is inserted into the message by the authentication system.

2. A method as claimed in claim 1 wherein the message is an encrypted message and the method includes the further step of decrypting the message by use of a key held by the user.

3. A method as claimed in claim 2 wherein the seed acts as a key for decryption of one or more future messages or wherein the seed is a partial key from which a complete key can be generated and the complete key is generated by combining the partial key with user authentication data.

4. A method as claimed claim 3 wherein the method involves the additional step of storing the seed for use as a key or for generating a key for decryption of one or more future messages.

5. A method as claimed claim 3 wherein the seed is a key having limited validity or wherein the seed generates a complete key having limited validity.

6. A method as claimed in claim 1 wherein the seed is encrypted along with the message or wherein the seed is transmitted in unencrypted form alongside an encrypted message.

7. A method as claimed in claim 1 wherein the seed is a symmetric key or an asymmetric public or private key or wherein the seed generates a symmetric key or an asymmetric public or private key.

8. A method as claimed in claim 1 wherein the seed is a partial seed, from which a full seed is generated by combining the partial seed with user authentication data.

9. A method as claimed in claim 1 wherein the pseudo-random character sequence is generated by inputting the seed into a suitable algorithm which includes linear congruential generators, lagged Fibonacci generators, linear feedback shift registers, and generalised feedback shift registers.

10. A method as claimed in claim 1 wherein the pseudo-random character sequence is displayed as a simple line of text and one character in the sequence is highlighted to indicate that it is currently available for selection and wherein once a character has been selected, a masked character representing this selection is displayed in an authentication data area of the display.

11. A method as claimed in claim 1 wherein the seed is also used as a key or for generating a key for the encryption of one or more messages sent by the user.

12. A method as claimed in claim 1 wherein the method includes the additional steps of: generating a pseudo-random character sequence; displaying said pseudo-random character sequence to the user; enabling the user to input authentication data by selecting one or more characters from the displayed pseudo-random character sequence; determining whether the authentication data is valid; and, if the authentication data is valid, and then sending a message, the method being characterised in that a seed for generating the pseudo-random character sequence is extracted from a previously received message.

13. A method for authenticating a user as a sender of a message, the method comprising the steps of: generating a pseudo-random character sequence; displaying said pseudo-random character sequence to the user; enabling the user to input authentication data by selecting one or more characters from the displayed pseudo-random character sequence; determining whether the authentication data is valid; and, if the authentication data is valid, sending the message, the method being characterised in that a seed for generating the pseudo-random character sequence is extracted from a previously received message, wherein the previously received message is received from or via an authentication system and the seed is inserted into the message by the authentication system.

14. A method as claimed in claim 13 the message is an encrypted message and the method includes the further step of encrypting the message by use of a key held by the user.

15. A method as claimed in claim 14 the seed acts as a key for encrypting of one or more future messages or wherein the seed is a partial key from which a complete key can be generated and the complete key is generated by combining the partial key with user authentication data.

16. A method as claimed in claim 15 wherein the seed is a key having limited validity or wherein the seed generates a complete key having limited validity.

17. A method as claimed in claim 13 wherein the seed is a symmetric key or an asymmetric public or private key or wherein the seed generates a symmetric key or an asymmetric public or private key.

18. A method as claimed in claim 13 wherein the seed is a partial seed, from which a full seed is generated by combining the partial seed with user authentication data.

19. A method as claimed in claim 13 wherein the pseudo-random character sequence is generated by inputting the seed into a suitable algorithm which includes linear congruential generators, lagged Fibonacci generators, linear feedback shift registers, and generalised feedback shift registers.

20. A method as claimed in claim 13 wherein the pseudo-random character sequence is displayed as a simple line of text and one character in the sequence is highlighted to indicate that it is currently available for selection and wherein once a character has been selected, a masked character representing this selection is displayed in an authentication data area of the display.

21. A secure messaging method incorporating the method for authenticating a user as recipient of a message in accordance with the method of claim 1 or as sender of a message in accordance with the method of claim 13.

22. A method as claimed in claim 21 wherein the secure messaging method is secure messaging method of the type wherein an authentication system stores identification information of a plurality of providing users and a plurality of receiving users and is adapted to: receive information from and authenticate at least one of said providing users; and transmit a message including said information via a mobile communications network to a receiving user's mobile terminal; further being adapted to: extract a public key specific to said receiving user from said stored identification information and to use said user specific public key for encryption of at least part of said message; provide a communication specific public/private key pair valid only for a single communication between the authentication system and said receiving user, wherein said communication comprises a message and a response thereto; encrypt at least part of said message using said communication specific private key; and send said communication specific public key to said receiving user as part of said message or send said communication specific public key to said receiving user terminal prior to said communication and store said communication specific public key in said mobile terminal.

23. A method of authenticating electronic payments comprising the steps of: sending a message to a user; authenticating the user in accordance with the method of claim 1; and thereby authenticating the payment.

24. A data transfer network operable to authenticate a user in accordance with the method of claim 1 or claim 13.

25. A device operable to authenticate a user in accordance with the method of claim 1 or claim 13.

26-51. (canceled)
